(19) United States
(12) Patent Application Publication
(10) Pub. No.: US 2013/0189170 A1
(43) Pub. Date: Jul. 25, 2013

(54) METHOD FOR RECOVERING YTTRIA FROM CASTING WASTE AND SLURRY

(71) Applicants: David James MONK, Rexford, NY (US); Jeffrey L. SCHWORM, Duanesburg, NY (US)

(72) Inventors: David James MONK, Rexford, NY (US); Jeffrey L. SCHWORM, Duanesburg, NY (US)

(73) Assignee: GENERAL ELECTRIC COMPANY, Schenectady, NY (US)

(21) Appl. No.: 13/353,751

(22) Filed: Jan. 19, 2012

(51) Int. Cl. C01F 17/00

(52) U.S. Cl. 423/21.1

(57) ABSTRACT

The disclosure relates generally to methods for yttrium recovery from articles. More specifically, the disclosure relates to methods for recovering yttrium from casting waste components and slurries.

### BACKGROUND

This disclosure relates to a method for recovering valuable rare earth elements from casting waste.

Modern gas or combustion turbines must satisfy the highest demands with respect to reliability, weight, power, economy, and operating service life. In the development of such turbines, the material selection, the search for new suitable materials, as well as the search for new production methods, among other things, play an important role in meeting standards and satisfying the demand.

The materials used for gas turbines may typically include titanium alloys, nickel alloys (also called super alloys) and high strength steels. For aircraft engines, titanium alloys are generally used for compressor parts, nickel alloys are suitable for the hot parts of the aircraft engine, and the high strength steels are used, for example, for compressor housings and turbine housings. The highly loaded or stressed gas turbine components, such as components for a compressor for example, are typically forged parts. Components for a turbine, on the other hand, are typically embodied as investment cast parts.

Although investment casting is not a new process, the investment casting market continues to grow as the demand for more intricate and complicated parts increase. Because of the great demand for high quality, precision castings, at lower cost and with less environmental impact, there continuously remains a need to develop new ways to make investment castings more quickly, efficiently, cheaply and of higher quality. As such, it is desirable to develop recovery processes that can be used on both casting waste and casting slurries interchangeably and are capable of maximizing recovery yield and purity.

Conventional investment mold compounds that consist of fused silica, cristobalite, gypsum, or the like, that are used in casting jewelry and dental prostheses industries are generally not suitable for casting reactive alloys, such as titanium alloys. One reason is because there is a reaction between mold titanium and the investment mold.

Yttrium oxide (Y₂O₃) is an important and useful metal casting refractory. It is thermodynamically stable in the presence of most reactive engineering metals including titanium, and titanium alloys. As such, crucibles and other casting materials used by the aviation industry for the manufacture of metal alloys contain yttrium, a valuable rare-earth element. The use of Y₂O₃ as a refractory material in both investment and core casting processes normally involves the production of casting shell molds and a slurry containing both Y₂O₃ and a hydrolyzed binder. Once the casting process is completed, the slurry and/or the casting shell mold are usually discarded. However, this is undesirable for both financial and environmental reasons.

Recycling of the casting shell mold and/or slurry to reclaim Y₂O₃ would offer a significant cost savings, and eliminate disposal problems. Indeed, recovery of yttria from waste crucibles and slurries has several advantages, including offsetting the need to purchase yttria for crucible manufacturing as well as eliminating disposal considerations. Presently, there is a need in the art for new and improved methods for recovering yttrium from such crucibles and slurries.

### SUMMARY

Aspects of the present disclosure provide for the recovery of yttria from investment casting mold materials or investment casting slurries. In one aspect, the present disclosure is a method for recovering yttrium from investment casting materials, said method comprising: milling the yttrium-containing casting waste, such that a flowable granular material is obtained; separating said granular material based on size; reacting at least a portion of the granular material with at least one agent, such that a soluble fraction forms comprising yttria, and an insoluble fraction is present comprising granular material; separating said soluble and insoluble fractions; and recovering the yttrium from the casting material.

The present disclosure allows for at least 90% of the dissolved yttria to be recovered. In one embodiment, 95% or more of the dissolved yttria is recovered. In a particular embodiment, 99% or more of the dissolved yttria is recovered. In another embodiment, the purity of the recovered yttria is 95% or more. In another embodiment, the purity of the recovered yttria is 99% or more.

In one embodiment, after the soluble and insoluble fractions are separated and before yttrium is recovered, the pH of the soluble fraction is adjusted. In another embodiment, after the soluble and insoluble fractions are separated and before yttrium is recovered, yttrium is precipitated from the soluble fraction. In one embodiment, after the soluble and insoluble fractions are separated, yttrium is precipitated from the soluble fraction and the yttrium fraction is separated from the soluble fraction. In one example, 90% or more of the dissolved yttria is recovered at a purity of about 95% or more.

In one embodiment, a crushing step, performed using for example a jaw crusher or other apparatus, results in pieces of casting waste no larger than one inch in any direction. A milling step reduces the size of the yttria to a flowable granular material while leaving any bulk alumina or metal as course pieces. In one example, milling results in pieces of casting waste of about one inch or less in any direction. In another example, milling results in pieces of casting waste of about 5 mm or less in any direction. Milling can be accomplished by a grinding mill, a hammer mill, a ball mill, a vibro mill, or a combination thereof. In one embodiment, a sieving step separates the pieces according to size. In one embodiment, the sieving step comprises using the sub 120 mesh fraction and the over 120 mesh fraction.

Another aspect of the present disclosure is a method for recovering yttrium from investment casting slurries, said method comprising: reacting the yttrium-containing investment casting slurry with at least one agent, such that a soluble fraction forms comprising yttria; separating said soluble fraction that contains the yttria from other insoluble fractions; and recovering the yttrium from the casting slurry. In one embodiment, after the yttrium-containing soluble fraction is separated from insoluble fractions and before yttrium is recovered, the pH of the soluble fraction is adjusted. In another embodiment, after the soluble and insoluble fractions are separated and before yttrium is recovered, yttrium is precipitated from the soluble fraction. In one embodiment, after the soluble and insoluble fractions are separated, yttrium is precipitated from the soluble fraction in the form of yttrium oxalate.

In certain embodiments, reacting comprises contacting at least one agent with the granular material, wherein said agent is at least one acid from a group consisting of nitric acid, hydrochloric acid, sulfuric acid, phosphoric acid, and combinations thereof to the granular material. In one embodiment, reacting comprises contacting at least one agent with the granular material, wherein said agent is at least one acid that is at a temperature of 30 degrees Celsius or higher. In one embodiment, the agent is an acid and the temperature of the acid during the reaction is at about 50 degrees Celsius or higher. In one embodiment, the agent is an acid and the temperature of the acid during the reaction is at about 80 degrees Celsius or higher. In one embodiment, the agent is an acid and the temperature of the acid during the reaction is at about 90 degrees Celsius or higher.

In another embodiment, reacting comprises contacting at least one agent with the granular material, wherein said agent is at least one acid that is at a concentration of 10% to 100%. In one example, the reacting step is for a period of about four hours or less. In one embodiment, a dissolving step results in a soluble fraction of about 70% and an insoluble fraction of about 30%. In another embodiment, after the separation of the soluble and insoluble fraction, the pH is adjusted to pH 0.25 to 5.0 and oxalic acid is added, such that yttrium is precipitated from solution. In one example, the yttrium is precipitated in the form of yttrium oxalate (Y₂(C₂O₄).9H₂O).

One aspect of the present disclosure is a method for recovering yttrium from investment casting materials or investment casting slurries, said method comprising: contacting investment casting flowable granular material or investment casting slurry with at least one acid, such that a soluble and insoluble fraction forms; adjusting the pH of the soluble fraction to achieve pH 2 or lower; and recovering the yttrium from the casting material or casting slurry. In one embodiment, after the pH of the soluble fraction is adjusted to about pH 2 or lower, oxalic acid is added, and yttrium is precipitated from solution in the form of yttrium oxalate.

In one embodiment, 90% or more of the dissolved yttria is recovered, and wherein the purity of the recovered yttria is 95% or more. In another embodiment, the contacting step comprises contacting the flowable granular material or slurry with at least one acid selected from a group consisting of nitric acid, hydrochloric acid, sulfuric acid, phosphoric acid, and combinations thereof. In one embodiment, the contacting step comprises adding at least one acid at a concentration of about 20% to about 40% for a period of time of up to about four hours to the flowable granular material or slurry. In one embodiment, the acid is at a temperature of 30 degrees Celsius or higher. In another embodiment, the acid is at a concentration of 10% to 100%. In one example, after the adjusting the pH and before recovering the yttrium from the casting material or casting slurry, the yttrium is precipitated from solution.

In one example, contacting with the acid is for a period less than about four hours. In another embodiment, contacting with the acid is for a period of about 6 hours or less. In another embodiment, contacting with the acid is for a period of about 8 hours or less. In another embodiment, contacting with the acid is for a period of about 12 hours or less. In yet another embodiment, contacting with the acid is for a period of about 24 hours or less. In one embodiment, contacting with the acid is for a period of time from about 1 hour to about 6 hours. In another example, the contacting step results in a soluble fraction of about 70% and an insoluble fraction of about 30%.

One aspect of the present disclosure is a method for recovering yttrium from investment casting materials, said method comprising: milling yttrium-containing casting waste to obtain flowable granular material; sieving the resultant flowable granular material to separate bulk pieces of casting waste and metal; contacting the flowable granular material with at least one acid; adjusting the pH of the soluble fraction to achieve pH 0.25 or higher; and recovering the yttrium from the casting waste. Another aspect of the present disclosure is a method for recovering yttrium from investment casting slurries, said method comprising: contacting the investment casting slurry with at least one acid, such that a soluble fraction forms containing yttria; adjusting the pH of the soluble fraction to achieve pH 0.25 or higher; and recovering the yttrium from the casting slurry.

In one embodiment, the pH of the soluble fraction is adjusted to pH 0.25 to pH 5. In another embodiment, the pH of the soluble fraction is adjusted to pH 1 to pH 2. In one embodiment, the pH of the soluble fraction is adjusted to be at pH of about 2 or lower. In a particular embodiment, the pH of the soluble fraction is adjusted to be 0.25 to about pH 5.

In one embodiment, milling results in pieces of casting waste of about one inch or less in any direction. The milling may also result in pieces of casting waste of about 5 mm or less in any direction. Milling may be accomplished by a grinding mill, a hammer mill, a ball mill, or a combination thereof. In one embodiment, sieving results in a flowable granular material in the range of about 0.1 mm to about 0.5 mm.

In one embodiment, the acid is selected from a group consisting of nitric acid, hydrochloric acid, sulfuric acid, phosphoric acid, and combinations thereof. In another embodiment, the contacting step comprises contacting the flowable granular material with at least one acid that is at a temperature of 30 degrees Celsius or higher. In one embodiment, the acid is at a temperature of 30 degrees Celsius or higher. In another embodiment, the acid is at a concentration of 10% to 100%. In one example, the contacting step is for a period of about four hours or less.

In one embodiment, after adjusting the pH and before recovering the yttrium from the casting waste, the yttrium is precipitated from solution. In another embodiment, after the flowable granular material is contacted with the acid, the soluble and insoluble fractions are separated, the pH of the soluble fraction is adjusted to about pH 2 or lower, oxalic acid is added to the soluble fraction, and yttrium is precipitated in the form of yttrium oxalate.

These and other aspects, features, and advantages of this disclosure will become apparent from the following detailed description of the various aspects of the disclosure taken in conjunction with the accompanying drawings.

### BRIEF DESCRIPTION OF THE FIGURES

The subject matter, which is regarded as the invention, is particularly pointed out and distinctly claimed in the claims at the conclusion of the specification. The foregoing and other features and advantages of the disclosure will be readily understood from the following detailed description of aspects of the invention taken in conjunction with the accompanying drawings.

FIG. 1 is a graph of particle size distribution (wt % vs. particle size) according to one embodiment.

FIG. 2 shows a plot of aluminum, titanium, and yttrium concentration for 35, 60, 120, and <270 mesh portions of milled crucibles according to one embodiment.

FIG. 3a recites the steps for recovering yttrium from investment castings in one embodiment.

FIG. 3b recites the steps for recovering yttrium from casting waste or casting slurry in one embodiment.

FIG. 3c recites the steps for recovering yttrium from investment castings according to a further embodiment.

### DETAILED DESCRIPTION

Yttrium oxide (Y₂O₃) is thermodynamically stable in the presence of most reactive engineering metals including titanium, and titanium alloys. As a result, casting materials used by the aviation industry for the manufacture of titanium aluminum alloys contain yttrium. Such casting materials are used in the process for manufacturing, for example, engine parts, including but not limited to engine turbine blades. Since Y₂O₃ is both expensive and poses disposal considerations, the recovery of Y₂O₃ from waste casting materials offsets the need to purchase Y₂O₃ for casting materials manufacturing and saves both time and money. As such, it is desirable to develop recovery processes that can be used on both casting waste and casting slurries interchangeably and are capable of maximizing recovery yield and purity.

Applicant has invented a new and improved manner by which yttria can be recovered from casting materials waste or slurries. In particular, Applicant has invented methods for recovering high yields of yttrium at high purity from investment casting mold materials and investment casting slurries.

The use of Y₂O₃ as a refractory material in both investment and core casting processes normally involves the production of casting shell molds that contain a Y₂O₃ or a slurry that contains Y₂O₃, in each case in combination with other materials including hydrolyzed binders. Once the casting process is completed, the mold or slurry is usually discarded. However, this is undesirable for both financial and environmental reasons.

Recycling of the casting materials or slurry to reclaim Y₂O₃ offers a significant cost savings, and eliminates disposal problems. Indeed, recovery of yttria from investment casting slurries as well as from investment casting materials (such as crucibles, molds, casting waste, etc.) having yttrium oxide has several advantages, including offsetting the need to purchase yttria for crucible manufacturing as well as eliminating disposal considerations.

Casting materials, such as crucibles, used for TiAl alloys are fabricated by depositing sequential layers of slurry (flour) and particles (stucco). The first two or three layers are made up primarily of yttria with a silicate binder. The later layers are comprised of alumina. The layers are applied sequentially to a wax mold which is then melted for removal. The crucibles are fired to bind the layers together such that they are sufficiently rigid to facilitate melting of the TiAl alloy. A similar process is used for yttria protective layers in other metal processing.

In certain embodiments, the crucible comprises about 70% of alumina, about 25% of yttria, and about 5% of silica as a binder. Thus, yttria can comprise at least a quarter of the crucible. The investment casting process also involves the production of a slurry containing yttrium oxide and once the casting process is complete, this slurry is commonly discarded.

Aspects of the present disclosure provide for the recovery of yttria from investment casting materials such as crucibles, or from investment casting slurries. In one embodiment, yttria is mechanically removed from crucibles and recovered. The yttria and any contaminants are milled to facilitate separation of yttria from any contaminants. The semi-purified yttria is then chemically dissolved, precipitated, filtered, and washed, leaving pure yttrium oxalate. The yttrium oxalate is subsequently calcined under oxidizing conditions to yield high purity yttria. Additional processing can be performed to remove various impurities for higher purity yttria.

In one aspect, the present disclosure is a method for recovering yttrium from investment casting materials, said method comprising milling the yttrium-containing casting waste, such that a flowable granular material is obtained; separating said granular material based on size; reacting at least a portion of the granular material with at least one agent, such that a soluble fraction forms comprising yttria, and an insoluble fraction is present comprising granular material; separating said soluble and insoluble fractions; and recovering the yttrium from the casting material. The reacting, in one example, comprises contacting at least one agent with the granular material, and the agent is at least one acid selected from a group consisting of nitric acid, hydrochloric acid, sulfuric acid, phosphoric acid, and combinations thereof. In one example, the agent is at least one acid that is at a temperature of 30 degrees Celsius or higher when put in contact with the granular material or casting slurry. In one embodiment, the agent is an acid and the temperature of the acid during the reaction is at about 50 degrees Celsius or higher, about 80 degrees Celsius or higher, or is at about 90 degrees Celsius or higher.

In one example, after the soluble and insoluble fractions are separated and before yttrium is recovered, the pH of the soluble fraction is adjusted. In another example, after the soluble and insoluble fractions are separated and before yttrium is recovered, yttrium is precipitated from the soluble fraction. After the soluble and insoluble fractions are separated, yttrium may be precipitated from the soluble fraction and the yttrium fraction may be separated from the soluble fraction.

In another embodiment, the present disclosure is a method for recovering yttrium from casting waste, comprising: crushing and/or milling the yttrium-containing casting waste, such that a flowable granular material is obtained; sieving the granular material and separating particles based on size; dissolving at least a portion of the granular material, such that a soluble fraction forms comprising dissolved yttria, and an insoluble fraction is present comprising undissolved granular material; separating the soluble and insoluble fractions; adjusting the pH of said soluble fraction; precipitating yttrium from said soluble fraction; separating the yttrium fraction from the soluble fraction, calcining said yttrium fraction; and recovering the yttrium from the casting waste. The insoluble fraction contains the byproduct materials, including alumina and silica. The yttrium is precipitated from the soluble phase and forms an insoluble yttrium compounds that is subsequently filtered, washed and calcined.

Another aspect of the present disclosure is a method for recovering yttrium from investment casting materials or investment casting slurries. The method comprises contacting investment casting flowable granular material that is obtained from milling investment casting materials, or contacting investment casting slurries with at least one acid, such that a soluble and insoluble fraction forms. The pH of the soluble fraction is then adjusted to achieve pH 2 or lower; and the yttrium is recovered from the casting material or casting slurry. In one example, after the pH of the soluble fraction is adjusted to about pH 2 or lower, oxalic acid is added, and yttrium is precipitated in the form of yttrium oxalate.

Another aspect of the present disclosure is a method for recovering yttrium from investment castings. The method comprises crushing and/or milling yttrium-containing casting waste to obtain flowable granular material, which in certain examples is no larger than about one inch in any direction; sieving the resultant flowable granular material; contacting the sieved flowable granular material with at least one acid; filtering the soluble fraction; adjusting the pH to achieve about pH 2 or lower; precipitating yttrium oxalate from solution; and recovering the yttrium from the casting waste by, for example, calcining the yttrium fraction.

A crushing step, for example, can be performed using a jaw crusher or other apparatus, and results in pieces of casting waste no larger than one inch in any direction. A milling step reduces the size of the yttria to a flowable granular material while leaving any bulk alumina or metal as course pieces. In one example, milling results in pieces of casting waste of about one inch or less in any direction, and in another example, milling results in pieces of casting waste of about 5 mm or less in any direction. The milling can be accomplished by a grinding mill, a hammer mill, a ball mill, a vibro mill, or a combination thereof. In one embodiment, sieving results in a flowable granular material in the range of about 0.1 mm to about 0.5 mm.

The contacting comprises contacting the pieces of casting waste or granular material with at least one acid from the group comprising nitric acid, hydrochloric acid, sulfuric acid, phosphoric acid, and combinations thereof. In a particular embodiment, the contacting comprises contacting the pieces of casting waste or granular material with at least one acid that is at a temperature of about 30 degrees Celsius or higher. On one embodiment, the contacting comprises contacting the casting slurry with at least one acid from a group comprising nitric acid, hydrochloric acid, sulfuric acid, phosphoric acid, and combinations thereof to the granular material. In a particular embodiment, the contacting comprises contacting the casting slurry with at least one acid that is at a temperature of about 30 degrees Celsius or higher.

The concentration of the acid used and the temperature, as well as which particular acid is used and the manner in which it is put in contact with the granular material can affect the rate of the reaction between the acid and the granular material that contains the yttrium. In one example, contacting with the acid is for a period less than about four hours. In another embodiment, contacting with the acid is for a period of about 6 hours or less. In another embodiment, contacting with the acid is for a period of about 8 hours or less. In another embodiment, contacting with the acid is for a period of about 12 hours or less. In yet another embodiment, contacting with the acid is for a period of about 24 hours or less. In one embodiment, contacting with the acid is for a period of time from about 1 hour to about 6 hours.

The acid concentration in one example is 10% to 100% and the contacting is for a period of time of between about 1 hour to about 3 hours. In another example, the acid concentration is 10% to 40%. In a particular embodiment, the acid concentration is 30% to 40%. In one example, the contacting is for a period less than about four hours. In another example, the contacting results in a soluble fraction of about 70% and an insoluble fraction of about 30%. In one example, the contacting step results in the granular material dissolving. That is, once the granular material makes contact with an acid, for example, over a period of time the granular material dissolves. In another example, the contacting step results in a soluble fraction of about 80% and an insoluble fraction of about 20%. In one embodiment, the acid is selected from a group consisting of nitric acid, hydrochloric acid, sulfuric acid, phosphoric acid, and combinations thereof. In another example, the flowable granular material is put in contact with at least one acid that is at a temperature of 30 degrees Celsius or higher. As indicated above, the concentration of the acid can vary and in a particular example can be at a concentration of 10% to 100%. The acid, in one example, is put in contact with the granular material for a period of about four hours or less.

Once the agent such as an acid comes in contact with the granular material, a reaction occurs. The reacting, in one example, comprises contacting at least one agent with the granular material, wherein said agent is at least one acid that is at a concentration of 10% to 100%. In one example, the reacting step is for a period of about four hours or less, however, the reaction can be left for longer periods in other examples, where for example, less acid or acid at a lower concentration and/or acid at room temperature is used. In one embodiment, a reacting step results in a soluble fraction of about 70% and an insoluble fraction of about 30%. In another embodiment, after the separation of the soluble and insoluble fraction, the pH is adjusted to pH 0.25 to 5.0 and oxalic acid is added, such that yttrium is precipitated from solution. In one example, the yttrium is precipitated in the form of yttrium oxalate (Y₂(C₂O₄).9H₂O). One advantage of the presently disclosed method is that it can be applied to both casting waste and to a casting slurry.

The use of Y₂O₃ as a refractory material in both investment and core casting processes normally involves the production of a slurry containing Y₂O₃. Recycling of the slurry to reclaim Y₂O₃ offers significant cost savings, and eliminates disposal problems. In view thereof, Applicant discloses herein a new and useful method for recovering yttrium from investment casting slurry. The method comprises contacting investment casting slurry with at least one acid, wherein the acid is at a temperature above 30 degrees Celsius; filtering the soluble fraction, adjusting the pH to achieve about pH 2 or lower; precipitating yttrium oxalate from the solution; and recovering the yttrium from the casting slurry. In another example, the method for recovering yttrium from investment casting slurries, comprises reacting the yttrium-containing investment casting slurry with at least one agent, such that a soluble fraction forms comprising yttria; separating said soluble fraction that contains the yttria from other insoluble fractions; and recovering the yttrium from the casting slurry. After the yttrium-containing soluble fraction is separated from insoluble fractions and before yttrium is recovered, in one example, the pH of the soluble fraction is adjusted. In another example, after the soluble and insoluble fractions are separated and before yttrium is recovered, yttrium is precipitated from the soluble fraction. In one embodiment, after the soluble and insoluble fractions are separated, yttrium is precipitated from the soluble fraction in the form of yttrium oxalate.

Another aspect of the present disclosure is a method for recovering yttrium from investment casting materials, where the method comprises milling yttrium-containing casting waste to obtain flowable granular material. This flowable granular material is then sieved to separate bulk pieces of casting waste and metal. The flowable granular material, which is usually less than one inch in any diameter and typically about 5 mm or less in any direction, is the contacted with at least one acid; and the pH of the soluble fraction that forms is adjusted to achieve pH 0.25 or higher, and the yttrium is recovered from the casting material. In a certain aspect, the present disclosure is a method for recovering yttrium from investment casting slurries, where the investment casting slurry is put in contact with at least one acid, such that a soluble fraction forms containing yttria; and then the pH of this soluble fraction is adjusted to achieve pH 0.25 or higher; and yttrium is recovered from the casting slurry. In one embodiment, the pH of the soluble fraction is adjusted to pH 0.25 to pH 5. The pH of the soluble fraction is adjusted to pH 1 to pH 2, or to a pH of about 2 or lower in another example.

The present disclosure allows for at least 90% of the dissolved yttria to be recovered. In one example, 95% or more of the dissolved yttria is recovered. In another example, 99% or more of the dissolved yttria is recovered. The purity of the recovered yttria can be 95% or more, or in another example, the purity of the recovered yttria is 99% or more. In one embodiment, 95% or more of the dissolved yttria is recovered, and the purity of the recovered yttria is 95% or more. In one example, 90% or more of the dissolved yttria is recovered at a purity of about 95% or more.

The contacting, in one example, comprises contacting the pieces of casting waste or the casting slurry with at least one acid from a group consisting of nitric acid, hydrochloric acid, sulfuric acid, and phosphoric acid, and combinations thereof. In one embodiment, the contacting step comprises adding at least one acid at a concentration of about 10% to about 100% for a period of time of between about 30 minutes to about 180 minutes to the pieces of casting waste or slurry. In one example, the contacting step is for less than about four hours. The contacting, in one example, results in a soluble fraction of about 80% and an insoluble fraction of about 20%.

Mechanical Yttria Removal:

Alumina, which has a hardness of about 9 on the mohs scale is significantly harder than yttria. As such, it is possible to remove the yttria coating via mechanical means (for example grit blasting, scraping, crushing and milling). In one example, the yttria layers in the crucible were mechanically removed by scraping with a laboratory spatula, and the mechanically separated yttria can then be milled. The mechanically separated yttria was then milled. In certain embodiments, it isn't necessary to separate the yttria from the alumina and TiAl prior to chemical dissolution, but separation decreases the amount of acid needed and the residual contamination. One advantage of the present disclosure is that although in prior methods sufficient acid is required to cover all the casting waste, in the present disclosure, the powdered yttria is much lower in volume and therefore stoichiometric volumes of acid can be used.

In another example, a Jaw Crusher was used to prepare the crucibles for milling to remove yttria, for example, the Retsch BB 300 Crusher (semi-conductor grade), which can process 600 kg/hr (about 900 crucibles per hour). The yield can be 500 kg (about 800 crucibles) containing about 92 kg yttria (18% yttria). Crucibles can be crushed on a regular schedule or saved and processed in large batches. The jaw crusher can break a crucible into <1 inch pieces which are suitable for milling.

Milling:

As noted, alumina, which has a hardness of 9 on the mohs scale, is significantly harder than yttria. Metal contaminants are considerably more malleable than alumina or yttria. By taking advantage of these different physical properties it is possible to prepare the removed yttria for the initial purification process (e.g. sieving) by mechanical means (grinding or milling). The result, in one example, is a flowable granular material containing primarily yttria, with course particles of metal and alumina. In one example, yttria that was removed from the crucible using a spatula was ground in a mortar and pestle. This yielded a flowable granular material with some larger metallic flakes. In another example, a vibro mill was used to mill crushed crucibles into a flowable granular material with large metallic flakes and course alumina particles.

The equipment used for the milling can be, for example, a grinding mill, hammer mill, a ball mill, or a vibro mill. For example, the grinding mill SWECO DM10 High Amplitude Grinding Mill (elastomer or alumina liner) can be used, which can process approximately 450 kg/hr.

While it isn't necessary to separate the yttria from the alumina and metal prior to chemical dissolution, separation decreases the amount of acid needed (excess acid would be needed to dissolve any residual metal) and reduces the residual contamination (dissolved metal could be present with the yttria in the soluble fraction). Milling helps separate yttria and silica from metal and alumina, and is an improvement over the manual removal of metal by hand since it is both time consuming and very difficult to separate all metal by hand.

Moreover, milling pre-concentrates the yttria, thereby reducing the need for a large reactor and decreasing the amount of acid needed, as compared to other techniques. In one embodiment, about 75% pure yttria goes into the reactor. This is in contrast to previously reported methods of adding everything in to the rotating reactor (i.e. having less than about 6% pure yttria going into the reactor) and adding a large volume of acid, sufficient to cover all the solids. As a result, in contrast to the conventional process, the present disclosure provides for about 95% recovery of yttria. In one embodiment, the instant disclosure teaches a method for yttria recovery that is 95% or more. In one embodiment, the approximately 450 kg batch yields approximately 315-350 kg alumina commingled with approximately 105-135 kg material containing about 83 kg yttria (60-80% yttria).

Sieving:

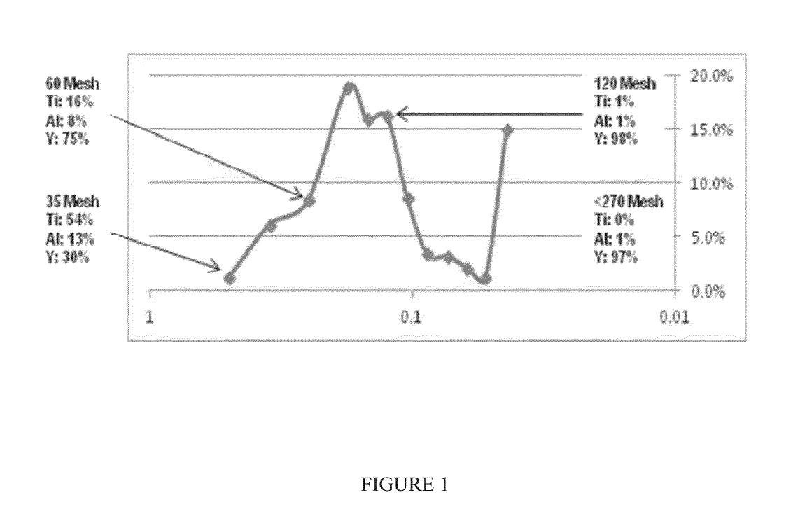

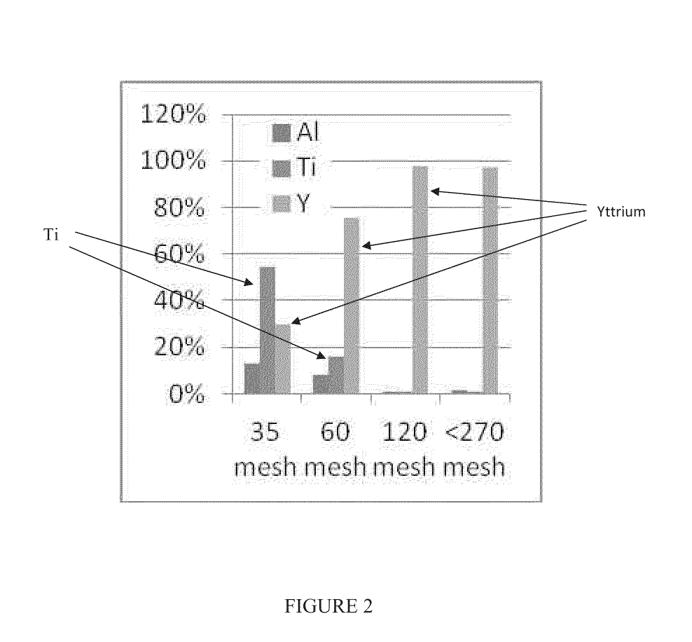

Yttria, removed from the crucibles and milled, is processed through a sieving system. During one example, the yttria that was scraped from the crucible and ground and was sieved through 35, 45, 60, 80, 100, 120, 140, 170, 200, 230, and 270 mesh sieves using a Retsch Sieve Shaker. In one embodiment, a sieving step separates the pieces according to size. In one embodiment, the sieving step comprises using the sub 120 mesh fraction and the over 120 mesh fraction. The particle size distribution obtained is depicted in FIG. 1. Note, that the larger particle sizes (e.g. 35 mesh) contained the majority of titanium and aluminum metal, while the smaller particle sizes contained mostly yttria (see FIGS. 1 and 2). Larger particle size fractions can be re-milled for better metal/yttria separation. For this sieving, it is not necessary to separate the yttria from the alumina and metal prior to chemical dissolution, but separation decreases the amount of acid needed and the residual contamination as described above.

The equipment for the sieving step includes, for example, a screen separator (for e.g. a SWECO Round Separator). According to one experiment, the yield can be approximately 450 kg, with approximately 315-350 kg alumina (waste) and approximately 105-135 kg material containing about 83 kg yttria (60-80% yttria). Non-conforming material [>120 mesh] can be re-milled and re-sieved if it contains some yttria.

In FIG. 1, the x axis is sieve mesh in mm and the y axis is the percent of solids present on a given sieve. The rise at <270 is due to a pan that catches everything that goes through a 270 mesh sieve. The inventors determined at what particle size good separation of alumina and metal contamination could be obtained, while preconcentrating yttria. Since 120 mesh achieved good separation of contaminants and preconcentration of yttria, no further sieve analysis was performed, however, it should be understood that mesh size in the range of greater than about 60 mesh and less than about 140 mesh would be acceptable, which corresponds to a particle size of about 0.1 mm to about 0.5 mm. Four points were analyzed via XRF, namely 35 mesh, 60 mesh, 120 mesh, and 270 mesh. Based on these experiments, the inventors determined the milling conditions to produce primarily under 120 mesh and over 120 mesh fractions.

In one embodiment, the crushing step results in pieces of casting waste no larger than one inch in any direction. The milling step results in finely powdered yttria with large metal and alumina pieces. The milling step can be accomplished by a grinding mill, a hammer mill, a ball mill, or a combination thereof. In one example, the sieving step separates the pieces according to size based upon the sub 120 mesh fraction and the over 120 mesh fraction.

Dissolution:

Yttria, and to some extent many metals, are soluble in strong acids (hydrochloric, nitric, sulfuric), while alumina and silica are not. In certain embodiments, other acids, such as phosphoric acid, are used. In certain embodiments, combinations of acid, are used.

Therefore, treatment of sieved yttria from new and used crucibles with strong acid dissolves the yttria and leaves the silica and alumina behind. In certain applications, it is advantageous to use <120 mesh powder for acid dissolution, since the finer particles react faster and also have less metal contamination.

The <120 mesh yttria that was removed from new and used crucibles, was refluxed in hydrochloric acid for 90 minutes, then filtered. The yttria forms highly soluble yttrium chloride. If the filtered solids still contain yttria, they can be re-milled, sieved, and dissolved again. In one embodiment, hot mineral acid, for example hydrochloric acid, is used to dissolve the crucible pieces. In certain examples, this process provides for a quick and more effective way to recover yttria.

For example, in one embodiment, the dissolving involves adding hot acid for a period of about 30 minutes to about 300 minutes. In one embodiment, the acid is in contact with the crucible pieces for about 30 minutes to about 90 minutes. In one embodiment, this dissolving includes the addition of acid, where the acid is in contact with the crucible pieces for about 30 minutes, about 60 minutes, about 90 minutes, about 120 minutes, or about 150 minutes. In one embodiment, the acid used is hot and concentrated. In one embodiment, the temperature of the acid is from about 30 to about 350 degrees Celsius. In another embodiment, the concentration of the acid is from about 3 M to about 18 M.

After dissolving, the insoluble fraction now contains alumina and silica and very little if any yttria. In contrast, the soluble fraction contains most of the yttria. The dissolution in one example is performed in a reactor/filter. The acid in one aspect is hydrochloric acid. In one embodiment, the hydrochloric acid is from between 10% to 40%. In a specific embodiment, the hydrochloric acid is at about 16%. In another embodiment, the hydrochloric acid is at about 36%. The yield, for example, can be close to 100%, and 20 kg batch yields about 16 kg Yttria equivalent as yttrium chloride. In one embodiment, the yield is more than 99%.

In certain embodiments, the dissolving comprises adding at least one acid from a group consisting of nitric acid, hydrochloric acid, sulfuric acid, and phosphoric acid to the granular material. In one example, the dissolving comprises adding at least one acid that is at a temperature of 30 degrees Celsius or higher. In another example, the dissolving step comprises adding at least one acid at a concentration of 10% to 100% for a period of time of about 1 hour to about 3 hours to the granular material. In one embodiment, the dissolving is for a period less than about four hours. In another embodiment, the dissolving results in a soluble fraction of about 70% and an insoluble fraction of about 30%. In another embodiment, after the separation of the soluble and insoluble fraction, the pH is adjusted to pH 1.0 and oxalic acid is added, such that Y₂(C₂O₄).9H₂O (yttrium oxalate) is precipitated from solution.

Other separation techniques are known in the art as well. For example, solvent extraction and ion exchange can be used to separate rare earths from each other in addition to other contaminants. In solvent extraction, a solvent into which rare earths will partition but other materials won't that isn't miscible in water is used, sometimes with a complexing agent, to separate rare earths from each other or from contaminants. The solvent is evaporated to recover the rare earth and the solvent can be reused. In ion exchange, an ion exchange resin that selectively or semi-selectively separates rare earths from contaminants is used to separate rare earths from each other and contaminants. After concentrating the rare earth on the ion exchange resin, a solvent is used to elute the desired rare earth and the ion exchange resin can be reused.

Precipitation/Filtration/Washing:

Yttrium forms an insoluble complex with oxalate. It precipitates from an acidic solution while any dissolved Ti and Al do not (they may precipitate at basic pH). Yttrium oxalate is least soluble between pH 0.5 and 5. The precipitate in one embodiment is filtered and washed with water to remove soluble impurities. Dissolved yttrium chloride in hydrochloric acid was adjusted to pH 1 with ammonium hydroxide (other bases work as well, but ammonium hydroxide is advantageous since it is driven off during calcining) and then a saturated solution of oxalic acid was added drop-wise until precipitation completed. The solids were filtered using a Whatman 50 filter and washed with a large volume of ultrapure water.

Other chemicals form complexes with yttrium and can be used for precipitation as well. For example, yttrium hydroxide is insoluble. However, Ti and Al hydroxides are also insoluble and may coprecipitate. The precipitation/filtration/washing steps can be performed in a reactor and through filters. The chemicals include ammonium hydroxide and oxalic acid. The yield in one example can be close to 100%. 100 crucible batch can yield approximately 13.5 kg yttria.

Calcining:

Yttrium oxalate degrades to form yttrium oxide at high temperature under oxidizing conditions. In one example, washed and dried yttrium oxalate from new and used crucibles was calcined in a muffle furnace under atmospheric conditions at 750 degrees Celsius for 1 hour with a 1 hour ramp up and 1 hour ramp down in temperature. The resulting white flowable powder was analyzed by XRF and found to be at least 99% yttria. The equipment for the calcining includes using a furnace. In one embodiment, 100 crucible batch yields approximately 13 kg of yttria.

The present disclosure in one example allows for at least 90% of the dissolved yttria to be recovered. In one embodiment, 95% or more of the dissolved yttria is recovered. In another embodiment, 99% or more of the dissolved yttria is recovered. In another embodiment, the purity of the recovered yttria is 95% or more. In another example, the purity of the recovered yttria is 99% or more. In a particular embodiment, more than 99% of the dissolved yttria is recovered and the purity of this recovered yttria is 99% or more.

Additional Steps:

If some yttria is encapsulated with silica or alumina, it may be necessary to pretreat it with an acid that dissolves silica or alumina. Such pretreatment has been used successfully to dissolve silica encapsulated yttria in thermal barrier coats.

Further Purification:

If significant impurities exist, it may be necessary to subject the yttria to additional dissolution/precipitation steps. For example, if yttria is contaminated with titanium dioxide, additional treatment with hydrochloric acid will dissolve the yttria leaving the titanium dioxide behind.

| | |
|---|---|
| Crushing (mechanical | (e.g. by Retsch BB 300 Jaw Crasher) |
| yttria removal) | |
| Milling | (e.g. by SWECO Grinding Mill) |
| Sieving | Coarse: 70% to 78%; Fine: 22% to 30% (about |
| | 1% is metal and about 99% is non-metal) |
| Dissolution & | Insoluble fraction is about 28%; soluble |
| Filtration | fraction is about 72% |
| Precipitation & | Soluble part is discarded; insoluble |
| Filtration | fraction is washed |
| Washing | Soluble part is discarded; insoluble |
| | fraction is calcined |
| Calcining | Volatile fraction with emission as water |
| | vapor and carbon dioxide; Non-volatile |
| | fraction is calcined. |
| Product | Recovery of 96% dissolved yttria with |
| | purity of about 99%. |

In one aspect, the present disclosure has several benefits over the conventional art. For example, the instant disclosure does not require drying prior to processing, and in the present disclosure the yttria is pre-concentrated by milling it from the bulk alumina. This milling process is advantageous for several reasons. First, the bulk alumina portion of the crucible is used as the milling agent (although other milling agents can be added if desired), which helps minimize contamination that could be introduced.

In addition, the milling process takes advantage of natural differences between the yttria material (which is friable and easily breaks down to fine particulates), metallic contamination (which is malleable and doesn't easily break down to fine particulates), and alumina contamination (which is hard and doesn't easily break down to fine particulates). Thus, milling facilitates mechanical separation of yttria from metals and alumina. The resulting yttria concentrate can be almost 80% pure. As such, the present disclosure provides for this finely powdered concentrate to be used which in turn requires a smaller reactor because the yttria is more concentrated to begin with. Combined with heating during digestion, the small particle size results in a faster overall dissolution process (as short as 30 to 60 minutes, compared to days in other methods), while achieving >99.9% purity. In the present disclosure, Applicant controlled the pH prior to precipitation, which has the effect of maximizing the yield. For example, pH is controlled by addition of a base. In a preferred embodiment, the applicant uses concentrated ammonium hydroxide as a base. Applicant achieved at least 99% yield as compared to significantly lower yields from other techniques.

In one aspect, the present disclosure has advantages over any prior art, as applied to slurries containing yttria in combination with a binder. For example, in the present disclosure, the slurry is dissolved directly—there is no need to form a solid mass from the slurry and thereby no need to pulverize the slurry prior to dissolving the yttria. Furthermore, according to the teachings of the present disclosure, there is no need to treat the slurry with a gelling agent, ignite the gel to remove and residual organic compounds contained within, processes which can add hours to the recovery method. The instant disclosure's improvements also result in a faster overall dissolution process (as short as 30 to 60 minutes, compared to several hours in other methods), while achieving >99.9% purity. In the present disclosure, the pH is controlled prior to precipitation, which has the effect of maximizing the yield. For example, pH is controlled by addition of a base. In a preferred embodiment, the applicant uses concentrated ammonium hydroxide as a base. In one embodiment, Applicant achieved at least 99% yield as compared to significantly lower yields from other techniques.

### EXAMPLES

The disclosure, having been generally described, may be more readily understood by reference to the following examples, which are included merely for purposes of illustration of certain aspects and embodiments of the present disclosure, and are not intended to limit the disclosure in any way.

FIG. 1 is a graph of particle size distribution (wt % vs. particle size) and related to the chemical composition for milled crucible from actual experimentation. Larger particle sizes (e.g. 35 mesh) contain low yttrium concentrations, while smaller particle (e.g. 120 mesh) sizes contain high yttrium concentrations. Sub 120 mesh was used because it has good separation of contaminants, high preconcentration of yttria, and has a high surface area to volume ratio which leads to fast dissolution. Other particle sizes could be used as well. For example, sub 80, sub 100, or sub 140 mesh. However, at 60 mesh there is significant metal contamination as shown in FIG. 1.

FIG. 2 shows a plot of aluminum, titanium, and yttrium concentration for 35, 60, 120, and <270 mesh portions of milled crucible from actual experimentation. Larger particle sizes (e.g. 35 mesh) contain low yttrium concentrations and significant titanium and aluminum contamination, while smaller particle (e.g. 120 mesh) sizes contain high yttrium concentrations and less contamination.

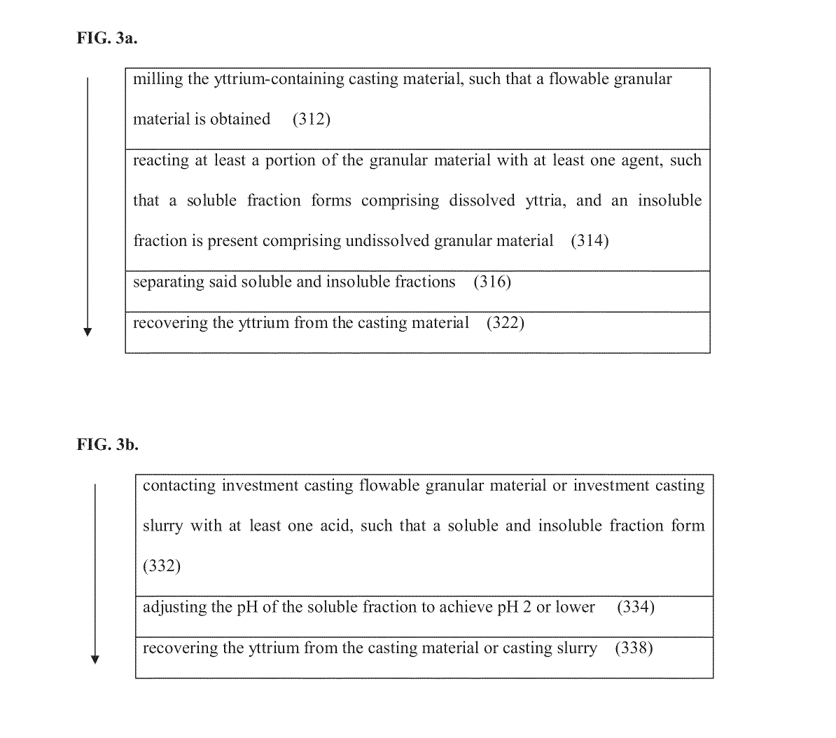

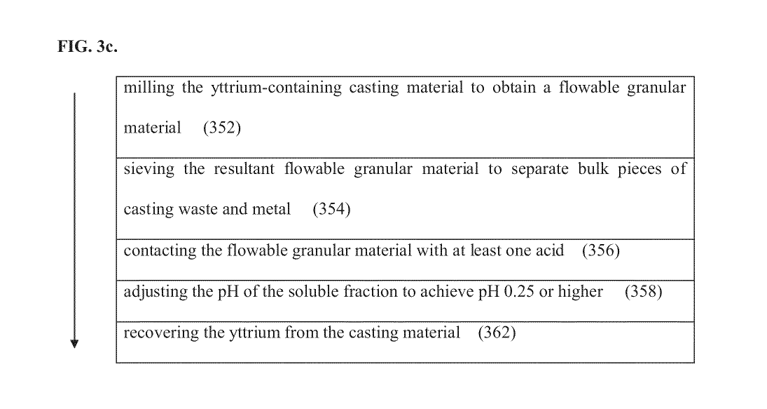

FIG. 3(a)-(c) shows a graphic of one aspect of the yttrium recovery process. In particular, FIG. 3(a) shows a method for recovering yttrium from investment castings. The method comprises milling the yttrium-containing casting material, such that a flowable granular material is obtained (312). Once a flowable granular material is obtained, at least a portion of this granular material is reacted with at least one agent, such that a soluble fraction forms comprising dissolved yttria, and an insoluble fraction is present comprising undissolved granular material (314). The soluble and insoluble fractions are then separated (316), and the yttrium is recovered from the casting material (322). In certain embodiments before the yttrium is recovered and after the separation of the soluble and insoluble fractions, the pH of the soluble fraction is adjusted. In other embodiments, after the pH is adjusted, yttrium is precipitated from the soluble fraction by, in one example, the addition of oxalic acid, wherein the precipitate that forms is yttrium oxalate.

FIG. 3(b) shows a method for recovering yttrium from investment casting waste or casting slurry. The method comprises contacting an investment casting flowable granular material or investment casting slurry with at least one acid, such that a soluble and insoluble fraction form (332). This material is dissolved such that a soluble fraction forms comprising dissolved yttria, and an insoluble fraction is present comprising undissolved material. The soluble and insoluble fractions are then separated, the pH is adjusted to achieve a pH of 2 or lower (334), and yttrium is recovered from the casting waste or slurry (338). In certain embodiments, yttrium is first precipitated from solution in the form of, for example, yttrium oxalate before the yttrium is recovered.

FIG. 3(c) shows a method for recovering yttrium from investment castings by milling the yttrium-containing casting material to obtain a flowable granular material (352). This granular material was then sieved to separate bulk pieces of casting waste and metal (354), and acid is introduced and put in contact with the flowable granular material (356). This material is dissolved such that a soluble fraction forms comprising dissolved yttria, and an insoluble fraction is present comprising undissolved material. The soluble and insoluble fractions are then separated. The pH of the soluble fraction was adjusted to achieve pH 0.25 or higher (358), and the yttrium was recovered from the casting waste (362). In certain embodiments, yttrium is first precipitated from solution in the form of, for example, yttrium oxalate before the yttrium is recovered.

In accordance with the present disclosure, used crucibles and slurries were treated to recover Y₂O₃. The crucibles contain approximately 20% Y₂O₃ in combination with other casting materials including, but not limited to, alumina and silica and residual metals including, but not limited to, titanium and aluminum. The slurries contained approximately 60% Y₂O₃ in combination with other materials including, but not limited to, water and silicate binders.

In one example, yttria was scraped from the surface of casting waste using a metal spatula. The material was milled to flowable granular material in a mortar and pestle then sieved using a Retsch sieve shaker. The 35, 40, 60, 80, 100, 120, 140, 170, 200, 230, 270, and <270 mesh fractions were weighed to determine the particle size distribution of the flowable granular material. The particle size distribution is shown in FIG. 1. XRF analysis was then performed on the 35, 60, 120, and <270 mesh fractions to determine how much yttria and metal contaminants were present. This data is shown in FIG. 1 and FIG. 2. The 120 mesh and <270 mesh fractions contained <2% metal impurities, while the larger fractions had less yttria and much more metal impurities. As such 120 mesh was chosen as the target particle size for flowable granular material. Other particle sizes could be used as well, based on experimental analysis, 120 mesh is non-limiting.

In one example, the inventor discovered milling time optimization for recovering Y₂O₃ from crucibles. The crucibles were milled and crushed to a size not exceeding 1.0 inch in any direction and milled in a polyethylene container on a vibratory mill for 180 minutes. No attempt was made to remove any metal contamination before milling. In 30 minute intervals, the milled crucible material was sieved to separate the sub 120 mesh fraction from the over 120 mesh fraction. These fractions were analyzed via XRF to determine Y₂O₃ content—over 96% of the total amount of Y₂O₃ contained in the crucibles was recovered after 180 minutes at a concentration of 62% Y₂O₃ by weight. At longer times, quantitative Y₂O₃ recovery is achieved. Less than 0.2% metallic contamination was present in the sub 120 mesh fraction.

In a second example, the temperature and reaction time optimization for recovering Y₂O₃ from crucibles was determined. To determine the optimal temperature and reaction time, several experiments were performed, as outlined below:

(1) 9.43 g of <120 mesh milled crucible containing 80% Y₂O₃ was added to a 500 mL round bottom flask. 45.7 mL of 16.5% hydrochloric acid was added and the mixture was stirred at room temperature. After 180 minutes, the suspension was removed from the flask, filtered, and washed to separate the solution from undissolved residue. The filtered solution was adjusted to pH 1.0 using ammonium hydroxide and 21 mL of 1.0 M oxalic acid was added. Precipitated Y₂(C₂O₄).9H₂O (yttrium oxalate) was filtered from solution, washed, dried, and calcined at 750 C for 3 hours. Under these conditions, 20% of the total Y₂O₃ was dissolved. The overall yield was 15% of the Y₂O₃ in the starting material.

This experiment demonstrated that lower temperatures and acid concentration conditions have a negative impact on reaction yield. Only 20% of the Y₂O₃ present was dissolved in 180 minutes, implying more than 15 hours would be required to dissolve everything, even using <120 mesh material. It is likely that for bulk particles, the time would be much greater (i.e. days) which is in agreement with prior art.

(2) 11.17 g of <120 mesh milled crucible containing 80% Y₂O₃ was added to a 500 mL round bottom flask. 49.2 mL of 37% hydrochloric acid was added and the mixture was stirred at reflux, approximately 50-60 degrees Celsius. After 30 minutes, the suspension was removed from the flask, filtered, and washed to separate the solution from undissolved residue. The filtered solution was adjusted to pH 1.0 using ammonium hydroxide and 104 mL of 1.0 M oxalic acid was added. Precipitated yttrium oxalate was filtered from solution, washed, dried, and calcined at 750 degrees Celsius for 3 hours. Under these conditions, 82% of the total Y₂O₃ was dissolved. The overall yield was 80% of the Y₂O₃ in the starting material at a purity of 99.9%. This experiment demonstrates that even at very short times, i.e. 30 minutes, the present disclosure can achieve results similar to those achieved by other methods over a period of days.

(3) 8.78 g of <120 mesh milled crucible containing 80% Y₂O₃ was added to a 500 mL round bottom flask. 42.5 mL of 16.5% hydrochloric acid was added and the mixture was stirred at reflux, approximately 100-110 degrees Celsius. After 90 minutes, the suspension was removed from the flask, filtered, and washed to separate the solution from undissolved residue. The filtered solution was adjusted to pH 1.0 using ammonium hydroxide and 98 mL of 1.0 M oxalic acid was added. Precipitated yttrium oxalate was filtered from solution, washed, dried, and calcined at 750 degrees Celsius for 3 hours. Under these conditions, 98% of the total Y₂O₃ was dissolved. The overall yield was 98% of the Y₂O₃ in the starting material at a purity of 99.9%.

(4) 9.12 g of <120 mesh milled crucible containing 80% Y₂O₃ was added to a 500 mL round bottom flask. 22.1 mL of 37% hydrochloric acid was added and the mixture was stirred at reflux, approximately 50-60 degrees Celsius. After 90 minutes, the suspension was removed from the flask, filtered, and washed to separate the solution from undissolved residue. The filtered solution was adjusted to pH 1.0 using ammonium hydroxide and 103 mL of 1.0 M oxalic acid was added. Precipitated yttrium oxalate was filtered from solution, washed, dried, and calcined at 750 degrees Celsius for 3 hours. Under these conditions, 100% of the total Y₂O₃ was dissolved. The overall yield was 99% of the Y₂O₃ in the starting material at a purity of 99.9%. This experiment supports one embodiment of the present disclosure. Quantitative dissolution and recovery was achieved very quickly, that is, in about 90 minutes by refluxing the <120 mesh material in 37% hydrochloric acid. Using the conditions herein, the present techniques achieve better recovery at the same or higher purity than any comparable method in the prior art and in a fraction of the time.

Preferred temperature of the acid will vary depending on the choice of acid. In one embodiment, the acid temperature is from about 30 degrees Celsius to about 350 degrees Celsius. For example, in one embodiment, the acid is concentrated sulfuric acid and is used at 350 degrees Celsius.

In a third example, the process for recovering Y₂O₃ from casting slurries was evaluated. To determine whether this technique could be used to recover Y₂O₃ from casting slurries, the following experiment was performed: 15.58 g of casting slurry, containing 26% water and 59% Y₂O₃ was added directly to a 500 mL round bottom flask. 55.8 mL of 16.5% hydrochloric acid was added and the mixture was stirred at reflux, approximately 100-110 degrees Celsius. After 90 minutes, the suspension was removed from the flask, filtered, and washed to separate the solution from undissolved residue. The filtered solution was adjusted to pH 1.0 using ammonium hydroxide and 131 mL of 1.0 M oxalic acid was added. Precipitated yttrium oxalate was filtered from solution, washed, dried, and calcined at 750 degrees Celsius for 3 hours. Under these conditions, 100% of the total Y₂O₃ was dissolved. The overall yield was 91% of the Y₂O₃ in the starting material at a purity of 99.9%. This experiment demonstrates recovering Y₂O₃ from casting slurries. Using the conditions described above, the same or better recovery and purity was achieved compared to than prior methods, and without gelling and drying steps.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

All publications, patents, and patent applications mentioned herein are hereby incorporated by reference in their entirety as if each individual publication or patent was specifically and individually indicated to be incorporated by reference. In case of conflict, the present application, including any definitions herein, will control. While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the disclosure may include only some of the described embodiments. Accordingly, the invention is not to be seen as limited by the foregoing description, but is only limited by the scope of the appended claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method for recovering yttrium from investment casting materials, said method comprising:
milling the yttrium-containing material, such that a flowable granular material is obtained;
separating said granular material based on size;
reacting at least a portion of the granular material with at least one agent, such that a soluble fraction forms comprising dissolved yttria, and an insoluble fraction is present comprising undissolved granular material;
separating said soluble and insoluble fractions; and
recovering the yttrium from the casting waste.

2. The method of claim 1, wherein milling results in pieces of casting waste of about one inch or less in any direction.

3. The method of claim 1, wherein milling results in pieces of casting waste of about 5 mm or less in any direction.

4. The method of claim 1, wherein after the soluble and insoluble fractions are separated and before yttrium is recovered, the pH of the soluble fraction is adjusted.

5. The method of claim 1, wherein after the soluble and insoluble fractions are separated and before yttrium is recovered, yttrium is precipitated from the soluble fraction.

6. The method of claim 1, wherein after the soluble and insoluble fractions are separated, yttrium is precipitated from the soluble fraction and the yttrium fraction is separated from the soluble fraction.

7. The method of claim 1, wherein 90% or more of the dissolved yttria is recovered, and wherein the purity of the recovered yttria is about 95% or more.

8. The method of claim 1, wherein reacting comprises contacting at least one agent with the granular material, wherein said agent is at least one acid from a group consisting of nitric acid, hydrochloric acid, sulfuric acid, phosphoric acid, and combinations thereof to the granular material.

9. The method of claim 1, wherein reacting comprises contacting at least one agent with the granular material, wherein said agent is at least one acid that is at a temperature of 30 degrees Celsius or higher.

10. The method of claim 1, wherein reacting comprises contacting at least one agent with the granular material, wherein said agent is at least one acid that is at a concentration of 10% to 100%.

11. The method of claim 1, wherein the reacting step is for about four hours or less.

12. The method of claim 1, wherein after the separation of the soluble and insoluble fraction, the pH is adjusted to pH 0.25 to 5.0 and oxalic acid is added, such that yttrium is precipitated from solution.

13. A method for recovering yttrium from investment casting materials or investment casting slurries, said method comprising:
contacting investment casting flowable granular material or investment casting slurry with at least one acid, such that a soluble and insoluble fraction form;
adjusting the pH of the soluble fraction to achieve pH 2 or lower; and
recovering the yttrium from the casting waste or slurry.

14. The method of claim 13, wherein 90% or more of the dissolved yttria is recovered, and wherein the purity of the recovered yttria is 95% or more.

15. The method of claim 13, wherein contacting comprises contacting the flowable granular material or slurry with at least one acid from a group consisting of nitric acid, hydrochloric acid, sulfuric acid, phosphoric acid, and combinations thereof.

16. The method of claim 13, wherein after the adjusting the pH and before recovering the yttrium from the casting waste or slurry, the yttrium is precipitated from solution.

17. The method of claim 13, wherein the acid is at a temperature of 30 degrees Celsius or higher.

18. The method of claim 13, wherein the acid is at a concentration of 10% to 100%.

19. The method of claim 13, wherein contacting is for a period of about four hours or less.

20. A method for recovering yttrium from investment casting materials, said method comprising:
milling the yttrium-containing casting material to obtain a flowable granular material;
sieving the resultant flowable granular material to separate bulk pieces of casting waste and metal;
contacting the flowable granular material with at least one acid;
adjusting the pH of the soluble fraction to achieve pH 0.25 or higher; and
recovering the yttrium from the casting waste.

21. The method of claim 20, wherein milling results in pieces of casting waste of about one inch or less in any direction.

22. The method of claim 20, wherein milling is accomplished by a grinding mill, a hammer mill, a ball mill, or a combination thereof.

23. The method of claim 20, wherein sieving results in flowable granular material in the range of about 0.1 mm to about 0.5 mm.

24. The method of claim 20, wherein 90% or more of the dissolved yttria is recovered, and wherein the purity of the recovered yttria is 95% or more.

25. The method of claim 20, wherein the acid is selected from a group consisting of nitric acid, hydrochloric acid, sulfuric acid, phosphoric acid, and combinations thereof.

26. The method of claim 20, wherein after the adjusting the pH and before recovering the yttrium from the casting waste, the yttrium is precipitated from solution.

27. The method of claim 20, wherein the acid is at a temperature of 30 degrees Celsius or higher.

28. The method of claim 20, wherein the acid is at a concentration of 10% to 100%.

29. The method of claim 20, wherein contacting is for a period of about four hours or less.

30. The method of claim 20, wherein after the flowable granular material is contacted with the acid, the soluble and insoluble fractions are separated, the pH of the soluble fraction is adjusted to about pH 2 or lower, oxalic acid is added to the soluble fraction, and yttrium is precipitated in the form of yttrium oxalate.
